(19) United States
(12) Patent Application Publication
(10) Pub. No.: US 2011/0290606 A1
(43) Pub. Date: Dec. 1, 2011

(54) VIBRATION DAMPING APPARATUS

(75) Inventor: Jeffrey N. Weisbeck, Orchard Park, NY (US)

(73) Assignee: ITT MANUFACTURING ENTERPRISES, INC., Wilmington, DE (US)

(21) Appl. No.: 12/789,913

(22) Filed: May 28, 2010

(51) Int. Cl. F16F 7/10

(52) U.S. Cl. 188/378

(57) ABSTRACT

An apparatus and method for damping vibrations within a physical object that is subject to vibration, such as for example, a railroad car running board. In one version, an enclosure is substantially filled with a granulated visco-elastic material, such as for example, granulated rubber, that is fixedly attached to the physical object.

### FIELD OF THE INVENTION

This invention generally relates to an apparatus and method for damping vibrations within physical objects that are subject to vibration, such as for example, a railroad car running board. According to one specific version of the invention, an enclosure is substantially filled with a granulated visco-elastic material, the enclosure being fixedly attached to a physical object such as a railroad car running board.

### BACKGROUND OF THE INVENTION

A railroad car running board is used to define a narrow walkway along either a side or a roof of a railway car. Typically, running boards are made from steel and are mounted to a railroad car via brackets that are secured to the railroad car. The running boards are typically attached to the brackets using bolts wherein each mounting bolt is passed through one of a plurality of mounting holes formed through each of the running boards. Nuts are threaded onto the bolts to secure the attachment between the running board and the brackets.

Over a period of standard use, the running boards typically wear out and fail at locations of attachment between the running board and the brackets. Wear and failure at these attachment points, as well as at other locations along the running board, are often the result of damage caused by vibrations that are transferred from the railroad car to the running board via the mounting brackets. These vibrations excite the fundamental natural frequencies of the running boards, resulting in increased stress at the locations of attachment. Other physical objects having similar mounting schemes can be subject to similar wear and failure modes.

### SUMMARY OF THE INVENTION

This invention relates to an apparatus and method for damping vibrations within a physical object that is subject to vibrational loads. According to one aspect, an enclosure is substantially filled with a granulated visco-elastic material, the enclosure being directly and fixedly attached to the physical object.

According to at least one version, the physical object is a railroad car running board, and the granulated visco-elastic material is granulated tire rubber. However, many different visco-elastic materials, including granulated polymer based materials also can provide an excellent result for vibrational damping of a railcar running board or other type of physical object.

The invention also provides for a method for damping vibrations within a physical object, wherein the method comprises the steps of: providing an enclosure that is substantially filled with a visco-elastic material and then fixedly and directly attaching the enclosure to the physical object. In one version of the invention, the physical object is a railroad running board and the visco-elastic material is granulated tire rubber. The invention also provides for a method for damping vibrations within a physical object, in which granulated visco-elastic material is placed within an existing cavity (void) of a physical object.

### BRIEF DESCRIPTION OF THE DRAWINGS

The objects and features of the invention can be better understood with reference to the claims and drawings described below. The drawings are not necessarily to scale, and the emphasis is instead generally being placed upon illustrating the principles of the invention. Within the drawings, like reference numbers are used to indicate like parts throughout the various views. Differences between like parts may cause those like parts to be each indicated by different reference numbers. Unlike parts are indicated by different reference numbers.

FIG. 1 illustrates a top perspective view of an enclosure that is substantially filled with visco-elastic material, in accordance with an exemplary embodiment of the invention;

FIG. 2 illustrates a side elevational view of the enclosure of FIG. 1 as attached to a railroad running board mounted onto a vibration testing apparatus;

FIG. 3 illustrates a bottom perspective view of the enclosure of FIGS. 1 and 2 as attached to a railroad running board of FIG. 2;

FIG. 4 illustrates a graph representing vibrational transfer to the railroad running board of FIG. 2 as a function of vibrational frequency, shown with the enclosure and without the enclosure for comparison; and

FIGS. 5A-5B illustrate various applications of the present invention in relation to at least one cavity located within a physical object.

### DETAILED DESCRIPTION OF THE INVENTION

FIG. 1 illustrates a first embodiment of a vibrational damping apparatus. This apparatus 100 includes an enclosure 110 that is substantially filled with a volume of granulated visco-elastic material 120 (also referred to synonymously as “visco-elastic material”). In this embodiment, the enclosure 110 is defined by a bottom surface (not shown) and a plurality of side surfaces 113 (not all shown in FIG. 1) that are made from a metal alloy, such as sheet metal. In other embodiments, the enclosure 110 can alternately be made from wood, plastic and/or other type of material that can suitably enclose the visco-elastic material and prevent migration of moisture into the enclosure 110. The bottom and side surfaces 113 are non-porous and designed to retain the visco-elastic material 120 within the confines of the enclosure 110.

As shown, the enclosure 110 includes a singular cavity within which the volume of granulated visco-elastic material 120 is retained. In other embodiments, the enclosure 110 can include multiple cavities that can each be employed to store visco-elastic material. Optionally, a cap or cover 118 can be attached to the top surface 111 to entirely seal the enclosure 110 in order to prevent leakage of the visco-elastic material from the confines of the enclosure 110. More particularly and according to this embodiment, the cap 118 is designed to be positioned and friction fitted (wedged) into an opening (shown) of the interior cavity 116, which is located along the top surface 111 of the enclosure 110 (as shown). The cap 118 functions as a plug to seal the interior cavity 116.

The interior cavity 116 of the enclosure 110 is substantially filled with the granulated visco-elastic material 120. Note that being “substantially filled” as intended herein does not require the interior cavity 116 to be entirely filled (packed) with visco-elastic material, in order to provide a benefit of substantial vibrational dampening. For example, filling (packing) the interior cavity 116 with visco-elastic material to at least about 75% of its maximum packed capacity, will provide substantial vibrational damping. In this specific embodiment, the enclosure 110 is configured into the shape of a rectangular box-like structure that is filled with the granulated visco-elastic material 120. The entire enclosure 110, which is also referred to hereinafter as a damping box 110, weighs approximately 1.7 pounds.

In this exemplary embodiment, the enclosure 110 includes an attachment mechanism that is designed to attach to a physical object, such as a railcar running board (also referred to throughout as “a running board”, or “railroad running board”). According to this embodiment, the attachment mechanism includes a set of four (4) threaded fasteners 112a-112d that are disposed in relation to the interior cavity 116 and are provided on the top surface 111. According to this embodiment, one pair of threaded fasteners 112a, 112b are disposed along one side of the opening and another pair of threaded fasteners 112c, 112d are provided on an opposite side of the opening, the latter of which is rectangular in shape according to this exemplary version.

Each of the threaded fasteners 112a-d according to this embodiment are threaded bolts that are oriented with the head of the bolt (not shown) disposed on the inner side of the top surface 111 and the shank position extending upwardly, as shown in FIG. 1. As shown, each threaded fastener 112a-112d is respectively and threadingly engaged to a nut component 114a-114d, securing the threaded fastener 112a-112d and the nut component 114a-114d to the enclosure 110. In the embodiment shown, the visco-elastic material 120 is granulated tire rubber 120 that can be seen through the top surface opening of the interior cavity 116.

According to this exemplary embodiment, the attachment mechanism is defined by the bolts 112a-112d including their nut counterparts 114a-d, which are designed to maintain direct physical contact between the enclosure 110 and the physical object (i.e., railcar running board) while the enclosure 110 is fixedly attached to the physical object. As for the embodiment shown, the specific physical dimensions of the enclosure 110 are 2.75 inches in height, 4.75 inches in width and 4.75 inches in depth. In other embodiments, the enclosure 110 can be designed and manufactured separate from an attachment mechanism, such as without the bolts for example, and/or be made from various other types of material and made of various shapes and sizes, providing that the visco-granulated material can be securely contained within the enclosure 110, while the enclosure 110 is fixedly attached to the physical object (railcar running board).

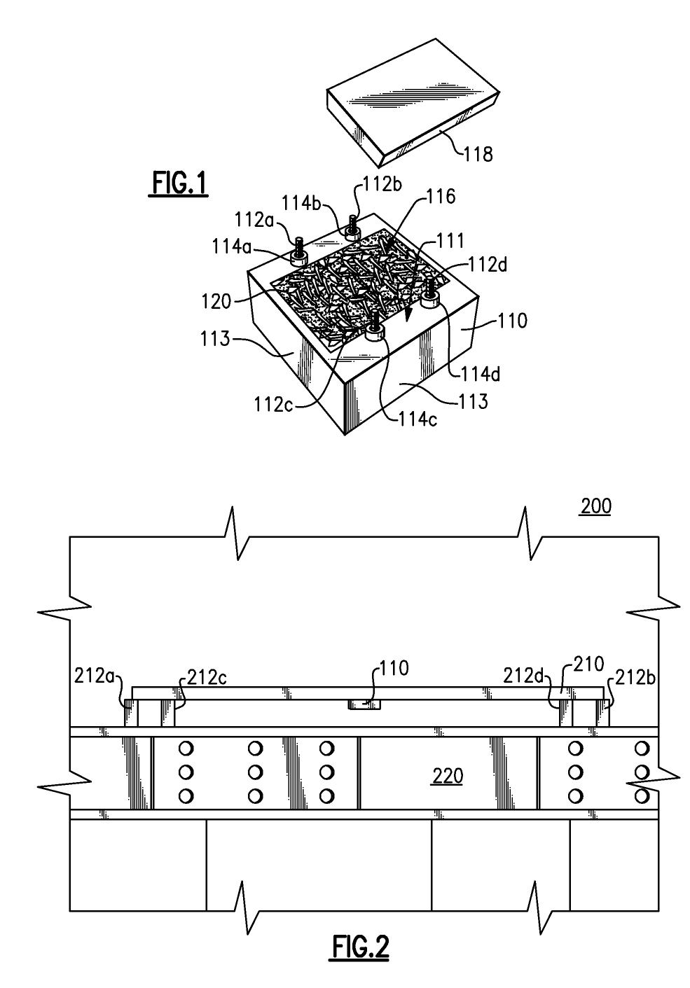

FIG. 2 illustrates a side elevational view of the enclosure 110 of FIG. 1 as attached to a railroad running board 210 that is mounted onto a vibration testing apparatus 200. As shown, the railroad running board 210, is fixedly mounted onto the vibration testing apparatus support 220 via (4) mounting supports 212a-212d that are located to engage each end corner of the running board.

The enclosure 110 is fixedly attached to the underside of the running board 210 via the attachment mechanism for enabling engagement between the threaded fasteners 112a-112d, each respective nut component 114a-114d, and the running board 210 itself. The running board 210 in this mounted position is disposed between the enclosure 110 and each nut component 114a-114d, (See FIG. 1), which is threadingly engaged to each threaded appendage 112a-112d, of the enclosure 110.

Note that the granulated visco-elastic material that is stored within the interior cavity 116 is not required to be in direct contact with the physical object. In accordance with the invention, the enclosure 110 is substantially filled with granulated visco-elastic material wherein the enclosure 110 is placed direct contact with the physical object while the enclosure 110 is fixedly attached to the physical object.

The vibration testing apparatus 200 is designed to transfer a spectrum of vibrational energy to the running board 210 via the mounting supports 212a-212d. The vibration testing apparatus 200 is also designed to measure the vibrational energy being transferred to the railroad running board 210 under test. Vibrational energy is transferred to the running board 210 via direct physical contact between each of (4) end corners of the running board 210 and a respective mounting support 212a-212d of the vibration testing apparatus 200. Each end corner of the running board 210 is bolted (not shown) to a respective mounting support 212a-212d of the vibration testing apparatus 200.

The mounting arrangement shown in FIG. 2 is an example of a typical mounting arrangement between the enclosure 110 of FIG. 1 and a running board 210. It should be readily apparent that other types of mounting arrangements can be employed. For example, and in other alternative mounting arrangements, a strap (not shown) could be employed to attach the enclosure 110, or another embodiment of the enclosure to the running board 210 or to another type of physical object for which vibration is to be dampened. Optionally, the threaded fasteners could instead be used to attach to another intermediate object, such as a strap engaging component (not shown), that acts as an accessory to the enclosure 110 and that facilitates attachment between the enclosure 110 and the strap (not shown).

FIG. 3 illustrates a perspective view of the enclosure 110 of FIGS. 1 and 2 as it is fixedly attached to the underside of the railroad running board 210 of FIG. 2 under test. As shown, the railroad running board 210 has a rectangular shape that includes a plurality of holes 312a-312c passing through the thickness of the railroad running board 210. The running board 210 shown herein is dimensioned to be 71.5 inches in length and 26.5 inches in width. Each of the threaded fasteners 112a-112d of the enclosure 110 are inserted upward and through a respective hole 312a-312c provided within the running board 210 while the nut component 114a-114d, FIG. 1, is threadingly engaged to each fastener 112a-112d from a upper side (not shown in this view) of the running board 210. In this embodiment, the plurality of holes 312a, 312b, 312c within the running board 210 enables a wide variety of locations to which the enclosure 110 can be attached to the running board 210.

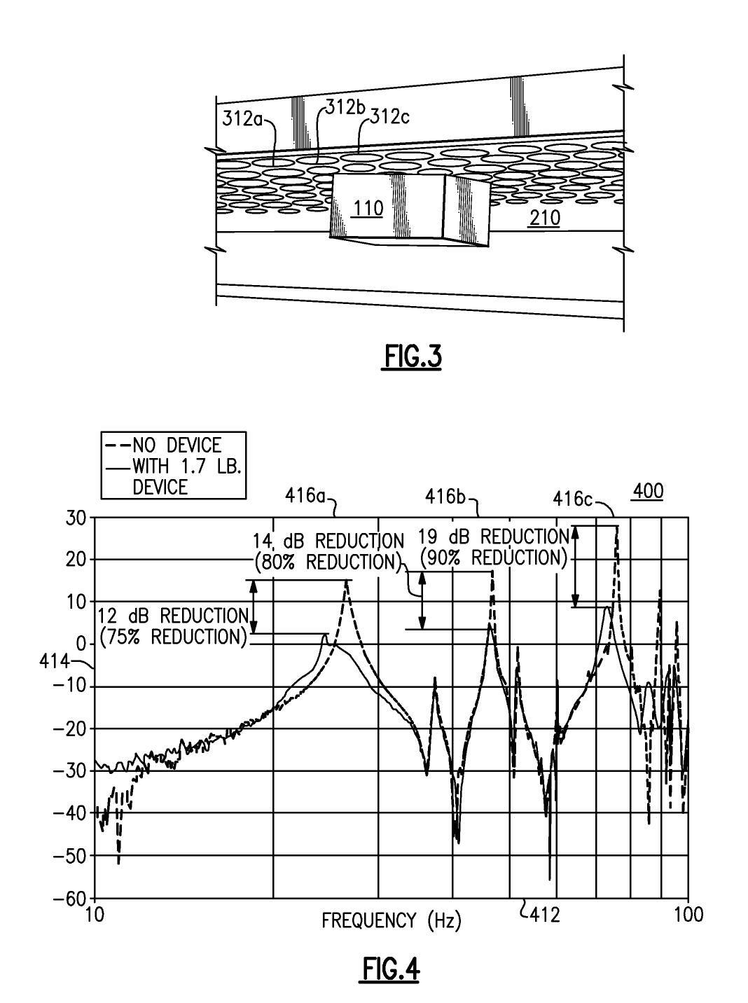

FIG. 4 illustrates a graphical representation 400 of output from the vibrational testing apparatus 200 based upon the transfer of vibrational acceleration to the running board 210 of FIGS. 2-3 as a function of vibrational frequency of that vibrational acceleration. The vibration testing apparatus 200 transfers vibrational acceleration to the running board 210 via the mounting supports 212a-212d.

As shown, the graph 400 includes a horizontal axis 412 and a vertical axis 414. The horizontal axis 412 indicates values of vibrational frequency (hertz) of vibrational acceleration (decibels) being transferred to the running board 210. The vertical axis 414 indicates a vibrational acceleration difference as measured in decibels, between vibrational energy of a running board 210 with an attached enclosure 110 and vibrational energy of a running board 210 without an attached enclosure 110 (dashed line). Note that decibel measurements are relative to a reference value, labeled as “0” marked on the vertical axis 414. Each decibel value represents vibrational acceleration within the running board 210 that is measured relative to the reference value.

Still referring to FIG. 4, vibrational acceleration is correlated to vibrational frequency, where vibrational frequency is measured within a range of 10 to 100 Hertz. The highest amounts of vibrational energy reside within vibrational acceleration peaks, also referred to as resonant peaks, appear to be located at frequency values of about 25 hertz, 416a, 45 hertz, 416b and 75 hertz,416c as indicated by 416a, 416b, and 416c on the graph 400. These peaks indicate an amplification of the vibrational energy within the running board 210 at these indicated frequencies 416a-416c.

As shown within this graph 400, the attachment of the vibrational damping apparatus 110 to the running board 210 causes a significant reduction of amplification of vibrational energy within the running board 210 at each of the indicated frequencies 416a-416c.

For example, this graph 400 indicates about a 75% reduction in vibrational energy within the running board 210 at about 25 hertz, about an 80% reduction at about 45 hertz and about a 90% reduction at about 75 hertz. The running boards 210 on railroad cars are failing at attachment locations between the running board 210 and the railroad car due to vibration (excitation) of the running board 210 at resonant frequencies caused by transfer of vibrational energy from an operating railroad train car.

In accordance with the invention, attachment of the vibrational damping apparatus 110 to a running board 210 substantially reduces these vibrational forces acting upon the running board at resonant frequencies, and as a result, reduces wear and tear of the running board 210 at the attachment locations to the railroad car and extends the useful life (longevity) of the running board 210, while it is attached to an operating railroad car.

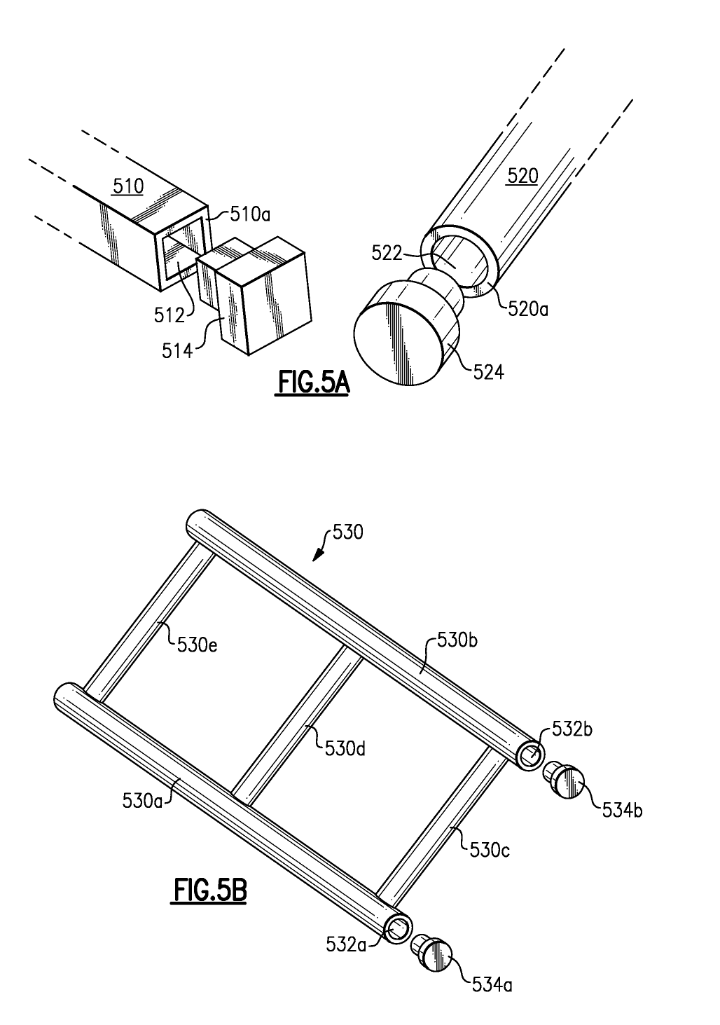

FIG. 5A illustrates a further application of the invention to at least one cavity (void) located within a physical object. As shown, a box beam 510 is a hollow type of structural beam having a square or rectangular shape. Other polygon shapes, such as trapezoidal, pentagonal etc. should be contemplated by one skilled in the art. The box beam 510 is hollow and defined by an interior cavity 512, also referred to as a void or voided cavity, which is visible through an open end 510a thereof.

Still referring to FIG. 5A, a cylindrical beam 520 is also a hollow type of structural beam having a circular cross-section. An interior cavity 522, is similarly visible through an open end 520a thereof. Both the box beam 510 and the cylindrical beam 520 are each typically employed as structural members within other structures in order to provide strength and support against loads directed towards the other structures including such structural members.

In accordance with the invention, and in order to dampen vibrations within the box beam 510, a volume of granulated visco-elastic material is disposed within the interior cavity 512 of the box beam 510. Likewise, to dampen vibration within the cylindrical beam 520 a volume of granulated visco-elastic material is similarly disposed within the interior cavity 522 of the cylindrical beam 520.

Optionally, the visco-elastic material can be packed tightly into either cavity 512, 522, but such tight packing is not required to obtain substantial vibrational damping characteristics of the invention. For example, filling (packing) of either cavity 512, 522 with granulated visco-elastic material to about 75% of its maximum packed capacity, provides substantial vibrational damping.

The granulated visco-elastic material is enclosed within either the box beam 510 or cylindrical beam 520 via an end cap 514, 524. The box beam 510 can be filled with visco-elastic material via its open end 510a. Upon filling, an end cap 514 is attached to the box beam 510 at its open end 510a to enclose the stored visco-elastic material. The end cap 514 is designed to function as a plug that is friction fitted into the cavity 512. Likewise, the cylindrical beam 512 can be filled with visco-elastic material via its open end 520a. Upon filling, an end cap 524 can be attached to the cylindrical beam 520 at its open end 520a to enclose the stored visco-elastic material stored. The end cap 524 is designed to function as a plug that wedges into the cavity 522.

In some embodiments, the end cap 514, 524 is designed to surround and optionally snap around each open end 510a, 520a. In other embodiments, as shown, the end cap is designed like a plug to partially enter and seal each respective cavity 512, 522 that is accessible from each open end 510a, 520a of either the box beam 510 or the cylindrical beam 520. The aforementioned embodiments of the end cap are designed to act as to prevent leakage of visco-elastic material from leaking (escaping) from either of the box beam cavity 512 or from the cylindrical beam cavity 522.

FIG. 5B illustrates a frame 530 that is constructed from an attachment of a plurality of hollow cylindrical beams 520 forming a frame-like (ladder-like) structure 530. In order to obtain vibrational damping characteristics of the invention, at least some or all of the cylindrical beams 530a-530e are substantially filled with granulated visco-elastic material within their respective cavities. As shown, cylindrical beams 530a and 530b are filled with visco-elastic material via their open ends 532a and 532b respectively. The visco-elastic material is enclosed within each respective hollow cylindrical beam 530a, 530b via end caps 534a and 534b respectively. The end caps 534a, 534b are designed to function as plugs that wedge into the cavities 532a and 532b, respectively.

In some embodiments of the invention, the frame 530 is constructed to constitute at least a portion of a running board. Optionally, a walking surface is layered and attached above the frame 530 to construct a railroad running board. Points of attachment of the running board can be created at locations on the frame 530 and/or on the walking surface (not shown). In other embodiments, the frame 530 can function as a frame or as scaffolding to support another type of surface, such as a wall or floor surface, or other structural component.

For purposes of this invention, “viscoelastic materials”refer to those materials for which the relationship between stress and strain depends on a duration of time of which a material is under stress. Some examples of viscoelastic materials include amorphous polymers, semicrystalline polymers, biopolymers, metals at very high temperatures, and bitumen materials such as asphalt. Although some types of polymers are classified as visco-elastic materials, other polymers are not so classified. There are also other non-polymer types of visco-elastic materials, such as bitumen classified materials including asphalt, for example. Some polymers are classified as being elastomers that are considered rubberlike and capable of being stretched, such as synthetic rubber, while other polymers are classified as non-elastomers. For example, some gels, such as whey protein gels, are considered to be visco-elastic, but are not rubber like.

Embodiments of the invention employ granulated visco-elastic material, and hence, employ visco-elastic material that is capable of being granulated. Some visco-elastic material, such as granulated tire rubber, has a bulk specific gravity of less than 1.0, which is less dense than water. While other types of visco-elastic material, such as asphalt, has a bulk specific gravity of greater than 1.0. Some visco-elastic materials, such as asphalt, can be a mixure of polymer based and non-polymer based materials.

### PARTS LIST FOR FIGS. 1-5B

100 vibration damping apparatus
110 enclosure
111 top surface, enclosure
112a threaded fastener
112b threaded fastener
112c threaded fastener
112d threaded fastener
113 side surface, enclosure
114a nut
114b nut
114c nut
114d nut
116 interior cavity
118 cap or cover, enclosure
120 visco-elastic material
200 vibration testing apparatus
210 running board
212a mounting support
212b mounting support
212c mounting support
212d mounting support
220 support-testing apparatus
312a hole
312b hole
312c hole
400 graph
412 horizontal axis
414 vertical axis
416a frequency value
416b frequency value
416c frequency value
510 box beam
510a open end of box beam
512 voided cavity of box beam
514 box beam end cap
520 cylindrical beam
520a open end of cylindrical beam
522 voided cavity of cylindrical beam
524 cylindrical beam end cap
530 frame
532a open end of cylindrical beam
532b open end of cylindrical beam
534a end cap for cylindrical beam
534b end cap for cylindrical beam

It will be readily apparent that other modifications and variations are possible within the intended ambits of the present invention, according to the following claims:

1. An apparatus for damping vibrations within a physical object, said apparatus comprising;
an enclosure substantially filled with a granulated visco-elastic material; and
an attachment mechanism designed for fixedly attaching at least one said enclosure to said physical object while maintaining direct physical contact between said enclosure and said physical object.

2. The apparatus of claim 1 wherein said physical object is a railroad running board.

3. The apparatus of claim 1 wherein said granulated visco-elastic material is granulated rubber.

4. The apparatus of claim 1 wherein said granulated visco-elastic material is granulated tire rubber.

5. The apparatus of claim 1 wherein said physical object is a railroad running board and wherein said granulated visco-elastic material is granulated tire rubber.

6. The apparatus of claim 1 wherein said attachment mechanism includes one or more threaded appendages extending from said enclosure that are each configured to engage another threaded component in order to fixedly secure attachment of said enclosure to said physical object.

7. The apparatus of claim 1, wherein said enclosure includes at least one interior cavity and a cap, said at least one interior cavity having an opening permitting said visco-elastic material to be transferred into said cavity and where said cap is designed to be inserted into said opening to seal said cavity.

8. The apparatus of claim 1 wherein said visco-elastic material includes a granulated and polymer-based material.

9. A method for damping vibrations within a physical object, said method comprising the steps of:
providing at least one enclosure that is substantially filled with a granulated visco-elastic material;
fixedly attaching said at least one enclosure to said physical object while maintaining direct physical contact between said at least one enclosure and said physical object.

10. The method of claim 9 wherein said physical object is a railroad running board.

11. The method of claim 9 wherein said visco-elastic material is granulated rubber.

12. The method of claim 9 wherein said visco-elastic material is granulated tire rubber.

13. The method of claim 9 wherein said physical object is a railroad running board and wherein said visco-elastic material is granulated tire rubber.

14. The method of claim 9 wherein said enclosure includes one or more threaded appendages that are each configured to engage another threaded component in order to fixedly secure attachment of said enclosure to said physical object, and where said fixedly securing attachment step includes a step of engaging said threaded component to each of said one or more appendages.

15. The method of claim 9 wherein said visco-elastic material includes a granulated and polymer based material.

16. A method for damping vibrations within a physical object including at least one cavity, the method comprising the steps of:
substantially filling at least one cavity included within a physical object with granulated visco elastic material; and
enclosing said granulated visco elastic material within said at least one cavity.

17. The method of claim 16 wherein said physical object is a railroad running board.

18. The method of claim 16 wherein said visco-elastic material is granulated rubber.

19. The method of claim 16 wherein said visco-elastic material is granulated tire rubber.

20. The method of claim 16 wherein said physical object is a railroad running board and wherein said visco-elastic material is granulated tire rubber.

21. The method of claim 16 wherein said physical object is a structural beam.

22. The method of claim 16 wherein said visco-elastic material is granulated and includes a polymer based material.
